(19) United States
(12) Patent Application Publication
(10) Pub. No.: US 2013/0343563 A1
(43) Pub. Date: Dec. 26, 2013

(54) HEADPHONE ASSEMBLY WITH INTEGRALGUITAR AMPLIFIER

(71) Applicant: SONIC EDGE, LLC, Sacramento, CA (US)

(72) Inventors: Marc Reiser, Calabasas, CA (US); Ben Fargen, Sacramento, CA (US)

(21) Appl. No.: 13/926,872

(22) Filed: Jun. 25, 2013

Related U.S. Application Data
(60) Provisional application No. 61/663,779, filed on Jun. 25, 2012.

(51) Int. Cl. H04R 1/10

(52) U.S. Cl. CPC H04R 1/1091
USPC 381/74

(57) ABSTRACT

A headphone assembly includes an integral guitar amplifier circuit for direct connection to a guitar.

### CROSS-REFERENCE TO RELATED APPLICATIONS

The present application claims benefit of and priority to U.S. Provisional Patent Application Ser. No. 61/663,779 filed Jun. 25, 2012 entitled HEADPHONE WITH INTEGRAL GUITAR AMPLIFIER, the entire content of which is hereby incorporated by reference herein.

### BACKGROUND

1. Field of the Disclosure

The present disclosure relates to a headphone assembly including an integral guitar amplifier.

2. Related Art

A guitar amplifier (or guitar amp) is an electronic amplifier designed to amplify the electrical signal of an electric or acoustic guitar so that it will produce sound through a loudspeaker. Most guitar amplifiers can also modify the instrument's tone by emphasizing or de-emphasizing certain frequencies and adding electronic effects. Vibrations of the strings are “picked up” by a suitable microphone. For electric guitars, strings are all made of metal, and the pickup works by electro-magnetic induction. Acoustic guitars have a normal microphone, designed to convert acoustic vibrations into an electrical signal, but usually they do so from direct contact with the strings (replacing the guitar's bridge) or with the guitar's body, rather than having a membrane like general-purpose microphones

A traditional guitar amplifier is generally housed in a relatively large speaker housing. These speaker housings take up a relatively large amount of space and are cumbersome and difficult to move around. Thus, musicians typically must devote specific spaces to playing and practicing music, which limits their flexibility.

Accordingly is would be beneficial to provide a guitar amplifier that avoids these and other problems.

### SUMMARY

It is an object of the present disclosure to provide a headphone assembly that includes an integral guitar amplifier.

A headphone assembly in accordance with an embodiment of the present disclosure includes a body, a connector configured for direct connection to a guitar and operable to receive an audio guitar signal, a guitar amplifier circuit, mounted in the body and in communication with the connector to receive the audio guitar signal, the guitar amplifier circuit operable to provide an amplified audio guitar signal based on the audio guitar signal and a transducer, mounted in the body and connected to the guitar amplifier circuit, the transducer operable to provide sound based on the amplified audio guitar signal.

In an embodiment, the headphone assembly includes a second body, a second guitar amplifier circuit, mounted in the second body and in communication with the connector to receive the audio guitar signal, the second guitar amplifier circuit operable to provide a second amplified audio guitar signal based on the audio guitar signal, and a second transducer, mounted in the second body and connected to the second guitar amplifier circuit, the second transducer operable to provide sound based on the second amplified audio guitar signal.

In an embodiment, the headphone assembly includes a flexible element connecting the first body and the second body.

In an embodiment, the headphone assembly includes a power supply mounted in the body and connected to the guitar amplifier circuit to provide power thereto.

The power supply may be a removable battery.

The power supply may be a rechargeable battery.

In an embodiment, the headphone assembly includes a recharging dock provided on the body and connected to the rechargeable battery to allow recharging thereof.

In an embodiment, the transducer may be removably mounted in the body and detachably connected to the guitar amplifier circuit.

In an embodiment, the headphone assembly includes a connection cable electrically connecting the connector to the guitar amplifier circuit.

In an embodiment, the headphone assembly includes a wireless transmission system configured to provide the guitar audio signal from the connector to the guitar amplifier circuit.

In an embodiment, the headphone assembly includes a transceiver mounted in the body and connected to the guitar amplifier circuit, the transceiver operable to receive the audio guitar signal or control signals operable to control the guitar amplifier circuit.

In an embodiment, the headphone assembly includes a second wireless transceiver connected to the connector and in wireless communication with the transceiver.

In an embodiment, the headphone assembly includes a clip connected to the body and configured to attach the headphone assembly to a user's head. The clip may be configured to connect the headphone assembly to a user's ear.

Other features and advantages of the present invention will become apparent from the following description of the invention which refers to the accompanying drawings.

### BRIEF DESCRIPTION OF THE DRAWINGS

FIG. 1 is a schematic view of a headphone assembly in accordance with an embodiment of the present disclosure connected to a guitar.

FIG. 2 is an exemplary block diagram of a headphone body in accordance with an embodiment of the present disclosure.

FIG. 3 is a more detailed view of an amplifier circuit of the headphone assembly in FIG. 1 including a preamplifier circuit and a power amplifier circuit.

FIG. 4 illustrates an exemplary embodiment of a headphone assembly in accordance with an embodiment of the present disclosure in which a speaker is removed from the headphone assembly.

FIG. 5 illustrates and exemplary embodiment of a cable used in the headphone assembly of FIG. 1.

FIG. 6 is an exemplary cross-sectional view of the cable of FIG. 5.

### DETAILED DESCRIPTION OF THE EMBODIMENTS

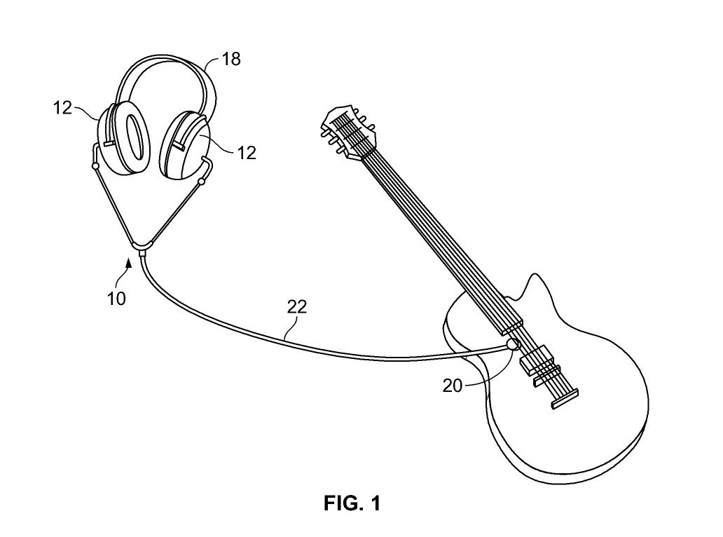

The headphone assembly 10 of the present application may be connected directly to a guitar G without the need for an external amplifier as is illustrated in FIG. 1, for example. An on board amplifier is provided in the headphone assembly 10 and coupled with proprietary “mini guitar amp speakers” to provide quality personal guitar amplifier sound in the same way a conventional professional guitar amplifier and speaker cabinet would interact for direct guitar play, but without the need or use of a separate amplifier and speaker set and including the flexibility of mobile battery powered usage.

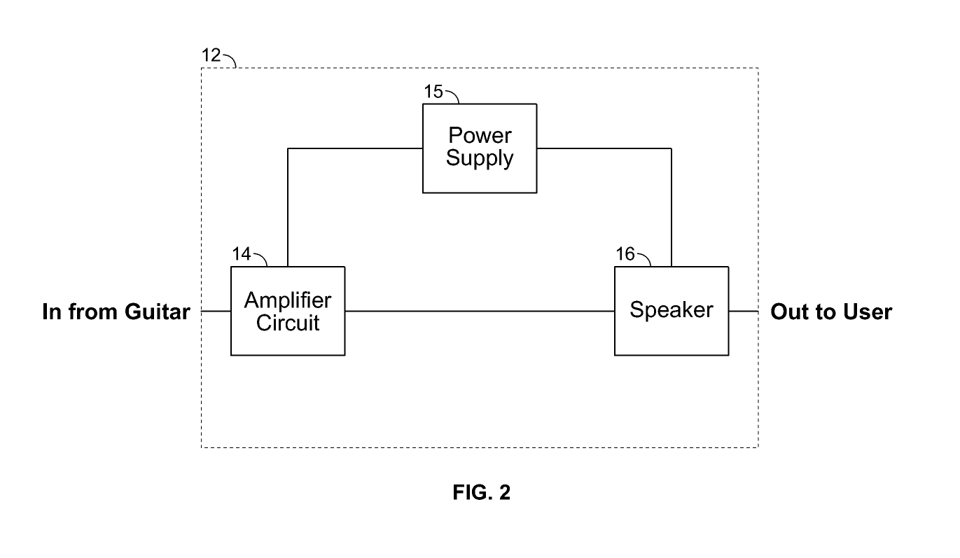

The headphone assembly 10 of the present disclosure is illustrated schematically in FIG. 1. In a preferred embodiment the headphone assembly 10 includes two headphone bodies 12. Each body 12 includes an amplifier circuit 14 and a speaker 16 (See FIG. 2, for example), or other transducer element, to provide sound. While it is preferred that two headphone bodies 12 are used, a single headphone body 12 may be used, if desired. A power supply 15 may also be provided in each of the headphone bodies 16. The power supply 15 may be a battery or any other suitable power supply. The power supply 15 may be removable or rechargeable, if desired.

In one embodiment, the headphone bodies 12 are connected to each other via a flexible element 18 that may placed on, or over, a user's head. The flexible element 18 preferably holds the headphone bodies 12 in position on the user's ears. In another embodiment, the headphone bodies 12 may be sized and shaped to stay in a user's ear without the need for the flexible body 18, if desired. In another embodiment, each headphone body 12 may include a clip, or other fastening element, to allow the headphone body to be secured on the user's ear.

A connector 20 is preferably provided for connection of the headphone assembly 10 to the guitar G. The connector 20 is preferably sized and shaped similar to a conventional connector used to connect guitars to amplifiers. More specifically, the connector 20 connects to a pick up of an electric guitar, or to a microphone included on an acoustic guitar.

A cable 22 preferably connects the connector 20 to the headphone assembly 10. In another embodiment, a wireless connection between the connector 20 and each headphone body 12 may be provided. In this case, a transmitter/receiver (not shown) is preferably included in the headphone bodies 12 to allow for reception, and, if desired, transmission, of wireless signals. More specifically, the cable 22 is preferably connected to each of the two headphone bodies 12. Each body 12 preferably includes an amplifier circuit 14 and speaker 16. More specifically, proprietary miniature “guitar” speakers 16 are built into the body 12 and interact with the on board amplifier circuit 14 in the same way a true professional guitar amplifier and speaker cabinet would interact. This differs from many conventional products that use a “simulated” guitar amp EQ curve to attempt delivery of correct playability and EQ response from a conventional headphone speaker set which is not designed for direct guitar play usage. The proprietary amp circuit 14 and speaker design provides a unique and necessary solution for plugging a guitar G directly into a headphone set. Conventional non-guitar specific amplifiers and headphone speaker designs do not provide the correct and specific frequency response needed to amplify a guitar signal correctly. A conventional amplifier and speaker set produces a harsh high frequency tonality along with unnatural harmonic distortion on high and low frequencies when used with guitar or guitar related products including but not limited to guitars, basses and mandolins, both electric instruments and acoustic instruments powered by electric pickups

The headphone assembly 10 preferably includes proprietary interchangeable speaker technology. (i.e. the ability to swap different styles speakers for different styles of play on the fly). That is, the speaker 16 may be removably mounted in the body 12 such that different speakers may be switched in and out to provide for different desired sounds or style of play. For example, a user may swap out a pair of speakers optimized for rock music, for a pair of speakers optimized for jazz. That is, the frequency response of the speaker 16 may be optimized for playing a particular type or genre of music. For example, for jazz music, the frequency response of the speaker is optimized for full range and zero distortion. In another example, for rock music, the frequency response of speaker 16 is configured to provide early distortion/overdrive followed with enhanced midrange frequencies.

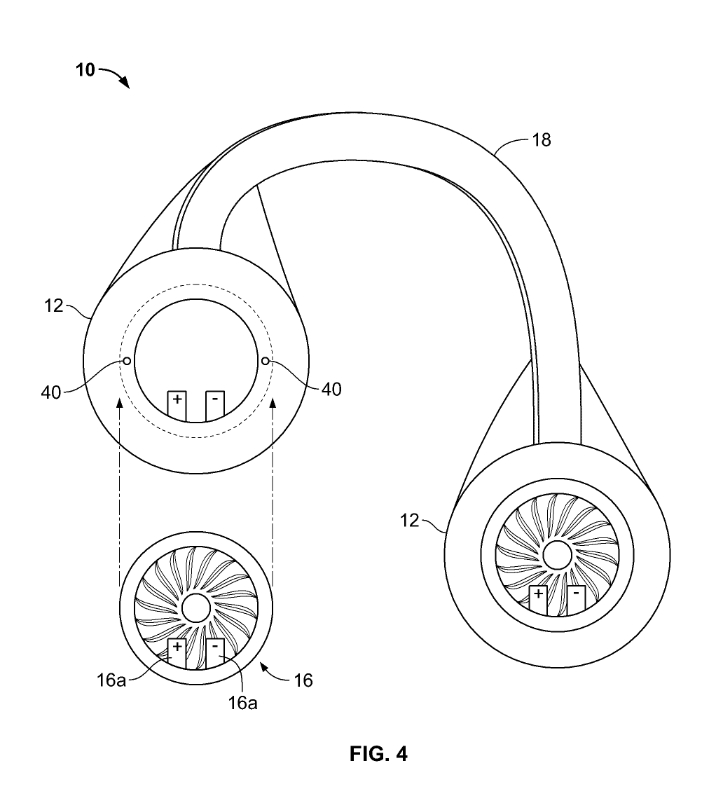

FIG. 4 illustrates an exemplary embodiment of the headphone assembly 10 showing a speaker 16 removed from the housing 12. In a preferred embodiment, the speaker 16 includes solder-less contact elements 16a that may be used to connect the speaker to the amplifier circuit 14, for example. Thus, the speaker 16 may be easily switched out and replaced by another speaker than may be optimized for a certain style of music, for example. In an embodiment, the electrical contacts of the speaker 16 may be implemented as snap fit fasteners to secure the speaker 16 in the housing 12. In a preferred embodiment, additional mechanical fasteners may also be provided as desired. Exemplary embodiments of these fasteners are generally illustrated as elements 40 in FIG. 4, for example. While snap fit fasteners are discussed above, any suitable fastener maybe used. The mechanical fasteners may be snap fit fasteners, clips or any other suitable fastener.

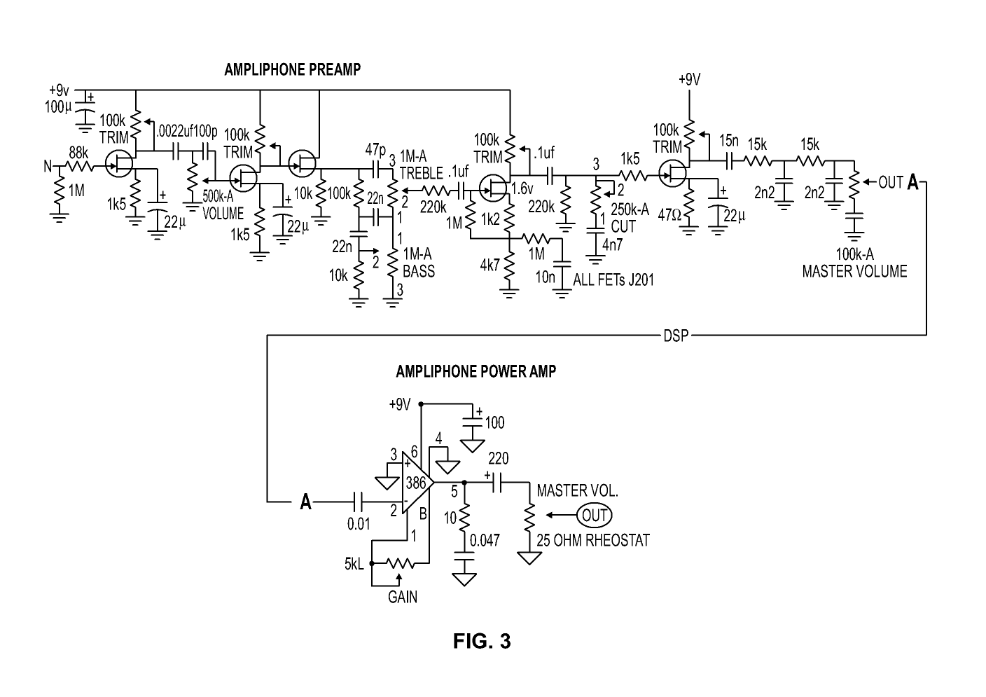

In a preferred embodiment, the amplifier circuit 14 is a modification of a preexisting Fargen circuit. The circuit 14 may include Fargen's “decade” technology, which predates any current production model available. The “decade” switch allows the user to switch between distinct circuits while still leveraging common portions of the design. As can be seen in FIG. 3, the amplifier circuit 14 may include a preamplifier component and a power amplifier component. The amplifier circuit 14 provides professional quality amplifier sound in a headphone monitoring system. The circuit is JFET based and uses tube design technology to allow for the placement of the circuitry inside the housing 12. That is, the circuit 14 is provided to meet the limited size and space requirements of the housing 12 while providing professional guitar amplifier sound quality. The circuit 14 allows for true professional quality amplification including appropriate EQ and frequency response in package small enough to be accommodated in the housing 12.

The headphone assembly 10 will allow for integration of multi-track recording direct to an on board RAM memory (not shown), for example, and/or to removable memory cards (not shown), for direct recording of the guitar source signal. The headphone assembly 10 will have the power to provide multitrack recording for the user. Multitrack recording (also known as multitracking or just tracking for short) is a method of sound recording that allows for the separate recording of multiple sound sources to create a cohesive whole. Multitracking became possible with the idea of simultaneously recording different audio channels to separate discrete “tracks” on the same tape—a “track” was simply a different channel recorded to its own discrete area on tape whereby their relative sequence of recorded events would be preserved, and playback would be simultaneous or synchronized.

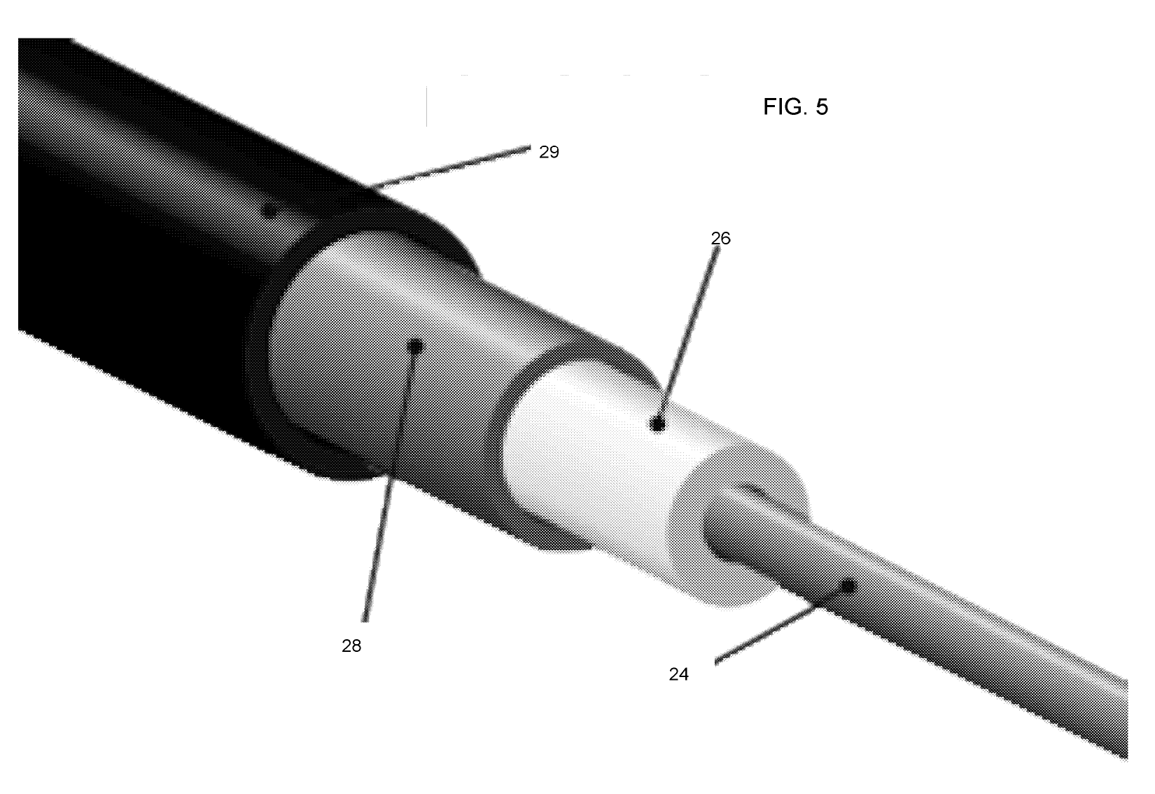

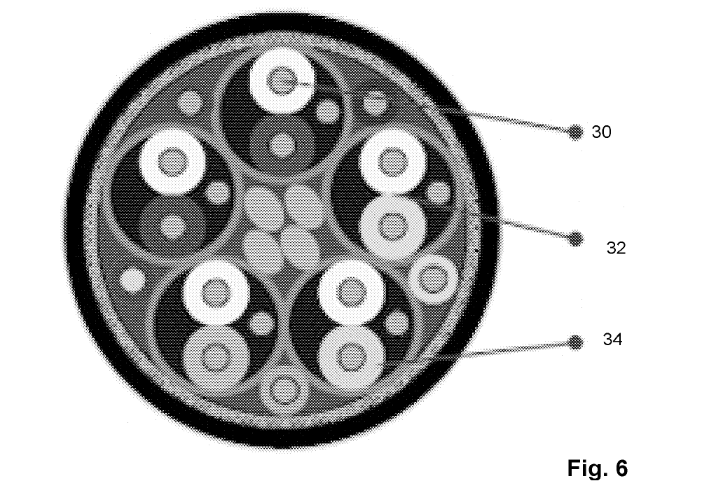

The cable 22 includes proprietary custom audio cabling that interconnects the guitar, amplifier 14 and bodies 12. The cable 22 is internally wired with proprietary audiophile polarized directional audiocable that will be custom built for the product, for the very best audio sound reproduction possible. FIG. 5 illustrates an exemplary embodiment of the cable 22. As illustrated, a central core 24 is surrounded by a dielectric insulator 26, which is in turn surrounded by a metallic shield 28 that is covered by a plastic jacket 29. The cable 22 is a multiple conductor audio and data cable. FIG. 6 illustrates an exemplary embodiment of the cable 22 showing the multiple conductors. Element 30 refers to a solid LGC (long-grain copper) conductor. Element 32 refers to a twisted pair for Ethernet and audio return. Element 34 refers to a polyethylene material. The headphone assembly 10 will preferably also include an on board stereo digital signal processing (DSP) based digital effects system built into amplifier circuit 14 and/or speaker 16, for example. This processing is preferably provided between the preamp circuit and the amplification stage illustrated in FIG. 3. An input device or devices (not shown) may be provided on the housing 12 to allow user input to adjust amplification, if desired.

As noted above, the power supply 15 may be rechargeable, that is, it may include a docking station with built-in charger. Wireless communication may be accomplished using of Bluetooth technology. Further, wireless communication may also be used to provide for control, or as the input device. In an embodiment, the headphone assembly 10 may be controlled or monitored wirelessly via a mobile device, for example, running a suitable software application or via a hardwired connection.

Although the present invention has been described in relation to particular embodiments thereof, many other variations and modifications and other uses will become apparent to those skilled in the art.

What is claimed is:

1. A headphone assembly comprising:
a body;
a connector configured for direct connection to a guitar and operable to receive an audio guitar signal;
a guitar amplifier circuit, mounted in the body and in communication with the connector to receive the audio guitar signal, the guitar amplifier circuit operable to provide an amplified audio guitar signal based on the audio guitar signal; and
a transducer, mounted in the body and connected to the guitar amplifier circuit, the transducer operable to provide sound based on the amplified audio guitar signal.
